(19) United States
(12) Patent Application Publication
(10) Pub. No.: US 2024/0331327 A1
(43) Pub. Date: Oct. 3, 2024

(54) IMAGE PROCESSING METHOD FOR VIDEO CONFERENCES

(71) Applicant: Continental Automotive Technologies GmbH, Hannover (DE)

(72) Inventors: Wolff von Spiegel, Mühltal (DE); Martin Gottwald, Babenhausen (DE); Daniel Naujack, Frankfurt am Main (DE); Jan Hermes, Frankfurt am Main (DE)

(73) Assignee: Continental Automotive Technologies GmbH, Hannover (DE)

(21) Appl. No.: 18/616,765

(22) Filed: Mar. 26, 2024

(30) Foreign Application Priority Data
Mar. 28, 2023 (DE) 10 2023 202 806.9

(51) Int. Cl. G06T 19/20; G06T 7/55; G06T 15/50; G06T 17/00; G06T 19/00; G06V 10/60; G06V 10/764; G06V 20/59

(52) U.S. Cl. CPC G06T 19/20; G06T 7/55; G06T 15/50; G06T 17/00; G06T 19/006; G06V 10/60; G06V 10/764; G06V 20/59; G06T 2207/10016; G06T 2207/10048; G06T 2207/20132; G06T 2207/20221; G06T 2207/30196; G06T 2207/30268

(57) ABSTRACT

A computer-implemented method for image processing in video conferences in a vehicle, wherein in a first reception step, first image data from a first camera and second image data from a second camera are received. The image data contain at least one image of an occupant of the vehicle. In a first extraction step, a depth information map is extracted using at least one of the two image data. In a second extraction step, features in the first image data are extracted. In a classification step, the features are classified as classified features, and include at least the occupant. In a fusion step, the depth information map and the classified features are fused to form a three-dimensional model. In a synthesis step, the first image data and the three-dimensional model are synthesized to form a synthesized image. In a display step, the synthesized image is displayed on a display device.

### CROSS REFERENCE TO RELATED APPLICATIONS

This US patent application claims the benefit of German patent application No. 10 2023 202 806.9, filed Mar. 28, 2023, which is hereby incorporated by reference.

### TECHNICAL FIELD

The present disclosure relates to the field of image processing methods. The present disclosure relates in particular to a computer-implemented method, to a computer program product, to a computer-readable storage medium and to a data carrier signal for image processing in video conferences in a vehicle. The present disclosure furthermore relates to a corresponding data processing device for a vehicle.

### BACKGROUND

Many devices and systems using which it is possible to conduct video conferences are already known, with image processing methods being used at the same time. By way of example, it is common in this connection to replace the background around the image of a participant with a graphic.

Undesirable effects often occur here, in particular at the edges of the image of the participant. One such undesirable effect is for example that the real background continues to be visible at the edges of the image of the participant, for example around the shoulders or the hair, and has not been replaced by a synthetic background.

Furthermore, owing to increasing mobility in society, it is desirable to adapt these video conferencing systems into a vehicle. However, existing video conferencing systems are not suited to the conditions that may prevail while driving. By way of example, when driving, image exposure is more dynamic as a result of constantly changing lighting conditions owing to street lights or other road users.

### SUMMARY

One object of the disclosure is therefore to provide a computer-implemented image processing method for video conferences in a vehicle that eliminates the abovementioned disadvantages. Another object of the disclosure is to provide a corresponding computer program product, computer-readable storage medium, data carrier signal and data processing device for a vehicle.

According to a first aspect of the disclosure, a computer-implemented method for image processing in video conferences in a vehicle with a first camera and a second camera has a reception step in which first image data from the first camera and second image data from the second camera are received. In this case, the image data contain an image of an occupant of the vehicle from slightly different perspectives. The method furthermore has a first extraction step in which a depth information map of the first image data is extracted using at least one of the two image data. The method furthermore has a second extraction step in which features in the first image data are extracted. In the following classification step of the method, the features are classified as classified features, wherein the classified features contain at least the occupant. The method also has a fusion step in which the depth information map and the classified features are fused to form a three-dimensional model. In the following synthesis step of the method, the first image data and the three-dimensional model are synthesized to form a synthesized image. The method has a display step in which the synthesized image is displayed on a display device.

The computer-implemented method thus defined is based on recognizing the occupant of the vehicle in the first image data and using the additional depth information to determine the region in the first image data that corresponds to the image of the occupant, specifically more precisely than with the methods used up to now. The depth information is generated here via the disparity between the first and second image data, which is why they contain an image of the occupant of the vehicle from slightly different perspectives. However, it is also possible to obtain the depth information map by other means. By way of example, it is possible to define and train an artificial neural network such that it creates a depth information map from just a single image.

Furthermore, features are extracted from the first image data and classified, this being able to be carried out by a person skilled in the art using customary machine learning means, for example using object detectors. The classified features in this case include at least the occupant.

A three-dimensional model may then be created from the depth information map and the classified features, which three-dimensional model consists for example of the classified features and their depth information. It is also possible to add the depth information to each pixel of the first image data.

Examples of classified features are the occupant, a backrest, other occupants, a coffee cup in the center console, but also shoulders, a nose, eyes, hair or glasses. Classified features may also be grouped or include other classified features. By way of example, the classified feature “occupant” could thus include the classified subfeatures “glasses”, “nose” or “mouth”.

By way of example, certain classified features may then be changed or removed from the resulting three-dimensional model. In other words, the first image data may be synthesized using the three-dimensional model. There are many synthesis options: By way of example, the background may be replaced or an artificial exposure situation may be generated.

Finally, the synthesized image is displayed on a display device and thus enables the occupant to participate in a video conference, with adverse effects in the image that is actually recorded being removed or displayed in improved form.

In one embodiment, at least one of the two cameras has the ability to generate image data from the infrared spectral range.

This embodiment is advantageous because image data in the infrared spectral range may be used to neutralize the external lighting conditions, for example using a difference in relation to image data in the visible spectral range. Features are then able to be extracted and classified more reliably regardless of the external illumination situation.

In a further embodiment of the method, the synthesis step comprises cropping the image of the occupant and/or replacing a background.

In one embodiment, the synthesis step comprises modifying illumination properties and/or reflectivity properties of the classified features of the three-dimensional model if at least one previously defined constraint is satisfied.

The reflectivity properties of the classified features often depend on the material of the feature. By way of example, the surface of an item of clothing made of wool reflects much more diffusely than a glasses frame made of aluminum. The illumination properties are extracted from the first image data and describe from where light sources emit, with what intensity, with what emission profile and in what direction. The illumination properties are integrated into the three-dimensional model.

The illumination properties and/or reflectivity properties should only be modified within previously defined constraints. Such constraints may for example be defined such that they correspond to a rapid change in the exposure conditions. In other words, a corresponding modification is carried out only if there is a rapid change in the exposure conditions, for example when driving along an illuminated road at night.

In one variant of the method, the previously defined constraints correspond to overexposure of a classified feature or a rapid change in the exposure of a classified feature.

In a further embodiment of the method, the modification of the illumination properties and/or reflectivity properties of the classified features comprises a third extraction step in which a reflectivity map is extracted on the basis of the three-dimensional model. Furthermore, this embodiment comprises a fourth extraction step in which the illumination properties and reflectivity properties of the classified features are extracted on the basis of the reflectivity map. In a modification step, the illumination properties and reflectivity properties of the classified features are modified to form modified illumination properties and modified reflectivity properties. Furthermore, in a generation step, the synthesized image is generated such that the illumination properties and reflectivity properties are replaced by the modified illumination properties and modified reflectivity properties.

If the external exposure conditions change, for example because the video conference is taking place in darkness along a road with street lighting, the occupant is illuminated differently within short time intervals. This is perceived as disruptive for the other participants in the video conference. Under such conditions, it is particularly desirable to modify the illumination properties and/or reflectivity properties of certain classified features.

If a corresponding constraint is detected, the illumination properties and/or reflectivity properties of the occupant or parts of the occupant may be modified in order thereby to create an artificial exposure environment. This artificial exposure environment negates the dynamic real exposure environment, such that the other participants in the video conference do not notice the dynamics of the image.

According to a second aspect of the disclosure, a computer program product contains instructions that, when the program is executed by a computer, cause said computer to carry out a computer-implemented image processing method for video conferences.

According to a third aspect of the disclosure, a computer-readable storage medium contains instructions that, when executed by a computer, cause said computer to carry out a computer-implemented image processing method for video conferences.

According to a fourth aspect of the disclosure, a data carrier signal transmits a computer program product that, when executed by a computer, causes said computer to carry out a computer-implemented image processing method for video conferences.

According to a fifth aspect of the disclosure, a data processing device for the vehicle is designed to carry out a computer-implemented image processing method for video conferences, wherein the data processing device has at least one processor that is configured such that it is able to carry out the steps of a computer-implemented image processing method for video conferences. Furthermore, the data processing device has at least one non-volatile, computer-readable storage medium that is communicatively connected to the at least one processor, wherein the at least one storage medium stores instructions in a programming language for performing the computer-implemented image processing method for video conferences. Furthermore, the data processing device has a first camera and a second camera that are communicatively connected to the at least one processor. The data processing device furthermore has a communication means and a display device that are communicatively connected to the at least one processor.

The data processing device is thereby able to be implemented as a single component but also to use distributed computing methods, for example by virtue of only the image data being sent to a cloud or a similar facility, in order to reduce the demand on the computing power in the vehicle and to transfer same to the cloud. It is also possible for a processor in the vehicle itself to perform the steps up to the classification of the features, but then to transmit all relevant data to the cloud in order to carry out the rest of the method steps there.

### BRIEF DESCRIPTION OF THE FIGURES

The disclosure will be explained in more detail below on the basis of exemplary embodiments with the aid of figures. In the figures:

FIG. 1: shows a flowchart of a computer-implemented image processing method for video conferences;

FIG. 2: shows one embodiment of a data processing device for a vehicle;

FIG. 3: shows a view of a vehicle with a second embodiment of a data processing device for a vehicle;

FIG. 4: shows a flowchart of a first embodiment of the computer-implemented method for image processing in video conferences in a vehicle; and

FIG. 5: shows a second embodiment of the computer-implemented method for image processing in video conferences in a vehicle.

### DETAILED DESCRIPTION

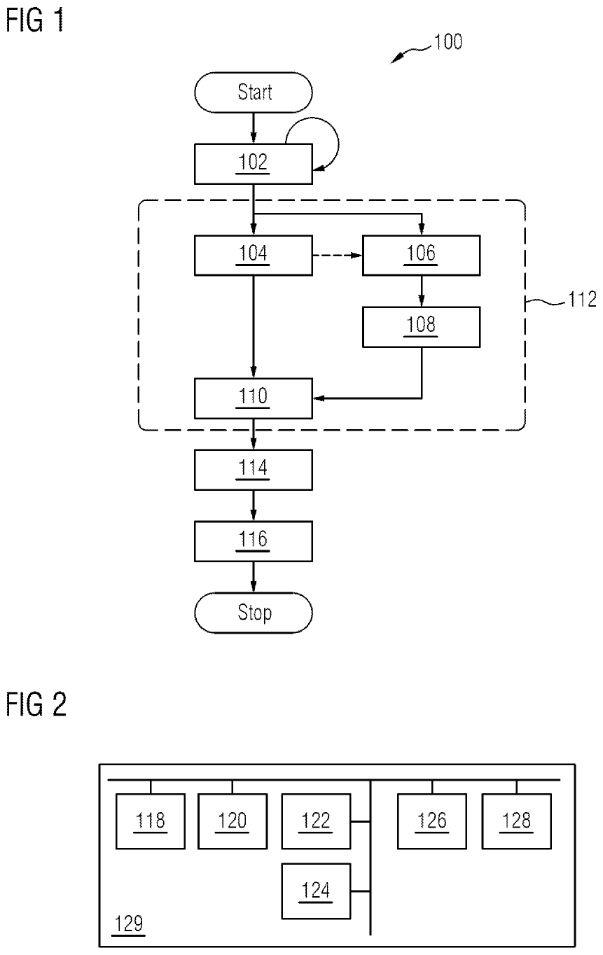

FIG. 1 shows a flowchart of a computer-implemented method 100 for image processing in video conferences in a vehicle 134.

In a reception step 102, first image data 142 from a first camera 122 and second image data 144 from a second camera 124 are received, wherein the image data 142, 144 contain an image of an occupant 132 of the vehicle 134 from slightly different perspectives. The cameras 122, 124 are part of the vehicle 134 here. The reception step 102 is carried out continuously, which is illustrated in FIG. 1 by the circular arrow in the reception step 102.

In a first extraction step 104, a depth information map 146 of the first image data 142 is extracted using at least one of the two image data 142, 144. In the depth information map 146, a depth is assigned to each pixel of the first image data 142. This may be done for example just from the first image data 142, preferably using machine learning means. It is also possible to create this depth information map 146 from the disparity between the first and second image data 142, 144.

In a second extraction step 106, features in the first image data 142 are extracted. Such features may for example be people or objects in the vehicle 134. However, ears, a nose, glasses or a mouth may also be understood to be features. Optionally, the depth information map 146 may be used to help extract the features in the first image data 142. This optionality is illustrated in FIG. 1 by the dashed arrow.

In the following classification step 108, the features are classified and are then available as classified features 148. In other words, an identifier is assigned to the digital data representing the features. In this case, the classified features 148 contain at least the occupant 132 of the vehicle 134.

In a fusion step 110, the depth information map 146 and the classified features 148 are then fused to form a three-dimensional model 152. In the three-dimensional model 152, the classified features 148 are recorded in space and, in particular, their position is known.

The first extraction step 104, second extraction step 106, classification step 108 and fusion step 110 may be understood to be an analysis part 112 of the computer-implemented method 100.

The counterpart to the analysis part 112 is a synthesis step 114, in which the first image data 142 and the three-dimensional model 152 are synthesized to form a synthesized image 154. In the synthesis step 114, a background may for example be removed or replaced. It is also possible to change the classified features 148 in the three-dimensional model 152 such that an artificial exposure situation is created.

In a display step 116, the synthesized image 154 is displayed on a display device 128. The display device 128 may be part of the vehicle 134 in which the occupant 132 is able to observe their image before or during the video conference. However, a display device 128 is usually also located with another participant 140 in the video conference.

FIG. 2 shows a first embodiment of a data processing device 129 for a vehicle 134.

The data processing device 129 for a vehicle 134 has a processor 118 that is configured such that it is able to carry out the steps of the computer-implemented method 100 from FIG. 1. Furthermore, the device 129 has a non-volatile, computer-readable storage medium 120 that is communicatively connected to the processor 118. The storage medium 120 stores instructions in a programming language for performing the computer-implemented method 100 from FIG. 1. Furthermore, the data processing device 129 has a first camera 122 and a second camera 124 that are communicatively connected to the processor 118. The data processing device 129 furthermore has a communication means 126 and a display device 128 that are communicatively connected to the processor 118.

The communicative connection between the individual elements of the data processing device 129 is illustrated in FIG. 2 by lines between the elements. The communicative connection may for example be a bus system.

In the example of FIG. 2, the data processing device 129 is designed as a single component and contains all of the technical means for carrying out the computer-implemented method 100 from FIG. 1.

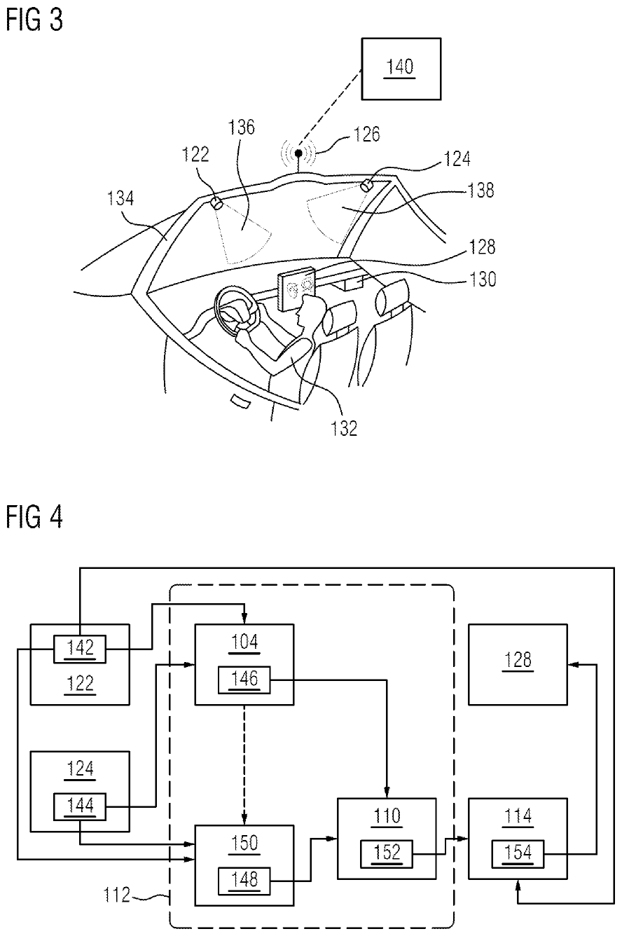

FIG. 3 shows a view of a vehicle 134 with a second embodiment of the data processing device 129 for a vehicle 134.

In contrast to FIG. 2, FIG. 3 shows an embodiment of the data processing device 129 in which the individual component parts of the device 129 are not implemented in a single component. On the contrary, there is a computing unit 130 in which the processor 118 and the storage medium 120 are housed. The first and the second camera 122, 124, the communication means 126 and the display device 128 are separate components in the vehicle 134 and may also be used by other systems in the vehicle 134. By way of example, the display device 128 is for instance part of an infotainment system.

In FIG. 3, the first camera 122 and the second camera 124 are installed at different positions at the upper end of the windshield. They are installed such that their viewing angle is able to capture the occupant 132 of the vehicle 134. In the example in FIG. 3, the occupant 132 corresponds to the driver. Owing to the different positioning of the cameras 122, 124, their image data 142, 144 contain an image of the occupant 132 from slightly different perspectives. If the cameras 122, 124 are calibrated accordingly, a depth information map 146 may be computed from the disparity between the first image data 142 from the first camera 122 and the second image data 144 from the second camera 124.

In the example of FIG. 3, all of the elements of the data processing device 129 are communicatively connected to one another, for example via the vehicle data network. The first image data 142 and the second image data 144 may thereby be communicated to the computing unit 130, which extracts the depth information map 146 in the first extraction step 104 and extracts the features in the second extraction step 106 and classifies said features in the classification step 108.

Furthermore, the computing unit 130 takes over the fusion step 110, which fuses the depth information map 146 and the classified features 148 to form a three-dimensional model 152. The synthesis of the first image data 142 and of the three-dimensional model 152 to form a synthesized image 154 in the synthesis step 114 is also taken over by the computing unit 130.

However, an alternative embodiment could also be designed such that the computing unit 130 carries out only the steps of the computer-implemented method 100 up to the classification step 108 and then transmits the classified features 148 and the depth information map 146 to a remote computing unit, such as a cloud, by way of the communication means 126. Said cloud could then carry out the further steps of the computer-implemented method 100 and provide the synthesized image 154 directly to the other participants 140 in the video conference.

In the example of FIG. 3, the synthesized image 154 is again transmitted, via the data lines of the vehicle 134, to the display device 128 for display in the display step 116. The synthesized image 154 is furthermore also transmitted to other participants 140 in the video conference by way of the communication means 126. The communication means 126 in the example of FIG. 3 is an apparatus for wireless communication over the mobile network.

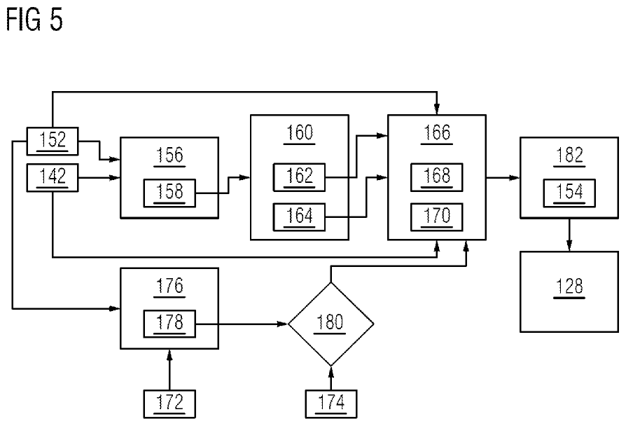

FIG. 4 shows a flowchart of a first exemplary embodiment of the computer-implemented image processing method 100 for video conferences.

In the exemplary embodiment of FIG. 4, first image data 142 from the first camera 122 and second image data 144 from the second camera 124 are first generated. The first image data 142 and second image data 144 are then processed in the first extraction step 104 to form a depth information map 146 of the first image data 142. This is done by computing the disparity between the first image data 142 and the second image data 144.

Furthermore, the first image data 142 and the second image data 144 in the example of FIG. 4 are made available to a neural network 150 that has been trained to be able to classify classified features 148 within the first image data 142. In other words, the second extraction step 106 and the classification step 108 are combined here in one step. A sufficiently large number of methods are known in the prior art for performing such classification of objects in image data.

The depth information map 146 and the classified features 148 are then fused to form a three-dimensional model 152 in a fusion step 110. A digital model that links the contents of the first image data 142 with depth information is thus then available.

The first image data 142 may then be synthesized to form a synthesized image 154 using the three-dimensional model 152. By way of example, all classified features 148 in the first image data 142 that do not correspond to the occupant 132 may be deleted. This would effectively crop the occupant 132 or remove the background.

In a final step, the display step 116, the synthesized image 154 is displayed on the display device 128.

FIG. 5 shows a flowchart of a second exemplary embodiment of the computer-implemented image processing method 100 for video conferences.

In the example of FIG. 5, the aim is to generate a synthetic exposure in the first image data 142. This is particularly advantageous when the image is highly dynamic, for example due to constantly changing real exposure conditions. Such a rapid change may be caused for example by the lights of a following vehicle or else by street lighting in relative darkness. A synthetic exposure situation may be used to mitigate these significant dynamic effects.

In the example of FIG. 5, the three-dimensional model 152 has already been created in a manner analogous to FIG. 4. Together with the first image data 142, the three-dimensional model 152 is used, in a third extraction step 156, to create a reflectivity map 158. The reflectivity map 158 contains information about the surface material, the distribution of light sources and observation geometry. In other words, the reflectivity map 158 implicitly contains information about the reflectivity properties 164 of the classified features and the illumination properties 162 in the first image data 142.

In a fourth extraction step 160, the reflectivity map 158 is used to extract the illumination properties 162 and reflectivity properties 164 of the classified features 148. This step is carried out in FIG. 5 with an appropriately trained neural network.

The three-dimensional model 152 is also made available to an analysis step 176 in which the classified features 148 are analyzed for the presence of a constraint 172. Such a previously defined constraint 172 may for example be the occurrence of an optical reflection.

If a previously defined constraint 172 has been detected as an event 178, the event 178 is compared against a previously defined limit value 174 in a comparison step 180. In the example of an optical reflection, the limit value 174 may be for example a specific exposure intensity. Such an optical reflection may arise due to the occupant 132 of the vehicle 134 wearing glasses and the position of the sun casting an optical reflection into the camera 122, 124.

If none of the previously defined constraints 172 exceeds the limit value 174, in the example of FIG. 5, the first image data 142 are displayed unchanged on the display device 128. However, if a previously defined constraint 172 is detected as being above the limit value 174, then the illumination properties 162 and the reflectivity properties 164 of the classified features 148 are modified in a modification step 166. The resulting modified illumination properties 168 and modified reflectivity properties 170 may for example be designed such that they no longer contain the optical reflection. In a generation step 182, the synthesized image 154 is generated such that the illumination properties 162 and reflectivity properties 164 are replaced by the modified illumination properties 168 and modified reflectivity properties 170. In other words, the synthesized image 154 no longer contains the optical reflection.

Finally, the synthesized image 154, which no longer contains the optical reflection, is transmitted to the display device 128 for display.

1. A computer-implemented method for image processing in video conferences in a vehicle, wherein the vehicle has a first camera and a second camera, the method comprising:
in a reception step, receiving first image data from the first camera and second image data from the second camera, wherein the image data contain an image of an occupant of the vehicle from slightly different perspectives;
in a first extraction step, extracting a depth information map of the first image data using at least one of the two image data;
in a second extraction step, extracting features in the first image data;
in a classification step, classifying the features as classified features, wherein the classified features include at least the occupant;
in a fusion step, fusing the depth information map and the classified features to form a three-dimensional model;
in a synthesis step, synthesizing the first image data and the three-dimensional model to form a synthesized image; and
in a display step, displaying the synthesized image on a display device.

2. The computer-implemented method as claimed in claim 1, wherein at least one of the two cameras has the ability to generate image data from the infrared spectral range.

3. The computer-implemented method as claimed in claim 1, wherein the synthesis step comprises cropping the image of the occupant and/or replacing a background.

4. The computer-implemented method as claimed in claim 1, wherein the synthesis step comprises modifying illumination properties and/or reflectivity properties of the classified features of the three-dimensional model if at least one previously defined constraint is satisfied.

5. The computer-implemented method as claimed in claim 4, wherein the previously defined constraint corresponds to overexposure of a classified feature or a rapid change in the exposure of a classified feature.

6. The computer-implemented method as claimed in claim 4, wherein the modification of the illumination properties and/or reflectivity properties of the classified features comprises:
in a third extraction step, extracting a reflectivity map on the basis of the three-dimensional model;
in a fourth extraction step, extracting the illumination properties and reflectivity properties of the classified features on the basis of the reflectivity map;
in a modification step, modifying the illumination properties and reflectivity properties of the classified features to form modified illumination properties and modified reflectivity properties; and
in a generation step, generating the synthesized image such that the illumination properties and reflectivity properties are replaced by the modified illumination properties and modified reflectivity properties.

7. A computer-readable storage medium containing instructions that, when executed by a computer, cause said computer to perform operations, comprising:
in a reception step, receiving first image data from the first camera and second image data from the second camera, wherein the image data contain an image of an occupant of the vehicle from slightly different perspectives;
in a first extraction step, extracting a depth information map of the first image data using at least one of the two image data;
in a second extraction step, extracting features in the first image data;
in a classification step, classifying the features as classified features, wherein the classified features include at least the occupant;
in a fusion step, fusing the depth information map and the classified features to form a three-dimensional model;
in a synthesis step, synthesizing the first image data and the three-dimensional model to form a synthesized image; and
in a display step, displaying the synthesized image on a display device.

8. A data processing device for a vehicle, the data processing device comprising:
at least one processor that is configured such that it is able to perform operations comprising:
in a reception step, receiving first image data from the first camera and second image data from the second camera, wherein the image data contain an image of an occupant of the vehicle from slightly different perspectives;
in a first extraction step, extracting a depth information map of the first image data using at least one of the two image data;
in a second extraction step, extracting features in the first image data;
in a classification step, classifying the features as classified features, wherein the classified features include at least the occupant;
in a fusion step, fusing the depth information map and the classified features to form a three-dimensional model;
in a synthesis step, synthesizing the first image data and the three-dimensional model to form a synthesized image; and
in a display step, displaying the synthesized image on a display device;
at least one non-volatile, computer-readable storage medium that is communicatively connected to the at least one processor, wherein the storage medium stores instructions in a programming language for performing a computer-implemented operation;
a first camera that is communicatively connected to the at least one processor;
a second camera that is communicatively connected to the at least one processor;
a communication means that is communicatively connected to the at least one processor; and
a display device that is communicatively connected to the at least one processor.
